(19) United States
(12) Patent Application Publication
(10) Pub. No.: US 2026/0260252 A1
(43) Pub. Date: Sep. 3, 2026

(54) METHODS AND SYSTEMS FOR UNIVERSAL PIXEL TRACKING WITH HIERARCHICAL ATTRIBUTION MATCHING

(71) Applicant: T-Mobile Innovations LLC, Overland Park, KS (US)

(72) Inventors: Aaron MCKEE, Hastings-on-Hudson, NY (US); Mariia KOSAREVA, London (GB)

(21) Appl. No.: 19/554,112

(22) Filed: Mar. 2, 2026

Related U.S. Application Data
(60) Provisional application No. 63/766,340, filed on Mar. 3, 2025.

(51) Int. Cl. G06Q 30/0201

(52) U.S. Cl. CPC G06Q 30/0201

(57) ABSTRACT

A method includes receiving pixel data from a universal pixel embedded in a website and exposure data from a publisher system, enriching the exposure data with program metadata to generate enriched exposure data, classifying identifier types present in the pixel data into different categories, matching engagement data against the exposure data based on the different categories of identifiers, and generating an attribution report identifying which targeted data delivery exposure led to a website conversion event.

### CROSS-REFERENCE TO RELATED APPLICATIONS

This application claims priority to U.S. Provisional Patent Application No. 63/766,340, filed March 3, 2025, titled "METHODS AND SYSTEMS FOR WEBSITE TRACKING USING A UNIVERSAL PIXEL," which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Universal pixels have been used in digital environments to collect user engagement data from websites and track interactions across web properties. These tracking systems typically embed JavaScript code or similar client-side executable code in website markup to capture user behavior and transmit data to remote servers for analysis and attribution purposes. Universal pixel implementations face technical challenges in heterogeneous identifier environments where device-level identifiers may be unavailable due to browser privacy settings, mobile operating system restrictions, or user opt-out mechanisms. These limitations create data processing inefficiencies and attribution matching failures that reduce system utilization and waste computational resources maintaining exposure datasets that cannot be effectively matched against conversion events.

### SUMMARY

In an embodiment, a universal pixel tracking system for website engagement attribution using hierarchical identifier-based matching is disclosed. The system includes a data processing system configured to receive pixel data from a universal pixel embedded in a website and receive exposure data from a publisher system describing targeted data delivery exposures served to user devices. The data processing system enriches the exposure data with program metadata to generate enriched exposure data. The program metadata includes at least one of publisher account identifiers, program names, targeting parameters, or program objectives. The data processing system classifies identifier types present in the pixel data into categories including at least one of a durable identifier, a household identifier, or an ephemeral identifier. When the pixel data comprises a durable identifier, the data processing system matches the pixel data against the enriched exposure data using the durable identifier within a first attribution window. When the pixel data comprises the household identifier corresponding to a residential network within a household, the data processing system matches the pixel data against the enriched exposure data using the household identifier to enable cross-device attribution within the household. When the pixel data comprises the ephemeral identifier, the data processing system matches the pixel data against the enriched exposure data using the ephemeral identifier and timestamps within a second attribution window. The data processing system generates an attribution report identifying which targeted data delivery exposure led to a website conversion event and transmits the attribution report to the publisher system. The system also includes a smart household system communicatively coupled to the data processing system. The smart household system is configured to maintain mappings between residential addresses and household identifiers and to receive addresses extracted from the pixel data and return household identifiers when the addresses correspond to residential networks.

In another embodiment, a method for hierarchical attribution matching using universal pixel data in a data processing system is disclosed. The method includes receiving pixel data from a universal pixel embedded in a website and receiving exposure data from a publisher system describing targeted data delivery exposures. The method includes enriching the exposure data with program metadata to generate enriched exposure data. The method includes classifying identifier types present in the pixel data into at least one of a durable identifier, a household identifier, or an ephemeral identifier. The method includes matching the pixel data against the enriched exposure data using the durable identifier within a first attribution window when the pixel data comprises the durable identifier. The method includes matching the pixel data against the enriched exposure data using the household identifier corresponding to a residential network within a household to enable cross-device attribution within the household when the pixel data comprises the household identifier. The method includes matching the pixel data against the enriched exposure data using the ephemeral identifier and timestamps within a second attribution window when the pixel data comprises the ephemeral identifier.

In yet another embodiment, a non-transitory computer-readable medium storing instructions is disclosed. When executed by one or more processors of a data processing system, the instructions cause the data processing system to receive pixel data from a universal pixel embedded in a website and exposure data from a publisher system. The instructions cause the data processing system to perform hierarchical attribution matching by comparing engagement data from the pixel data against enriched exposure data using available identifier types. The instructions cause the data processing system to generate an attribution report identifying targeted data delivery exposures that led to website conversion events.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a universal pixel tracking system for hierarchical attribution matching according to various embodiments of the disclosure.

FIG. 2 is a block diagram illustrating a method for hierarchical attribution matching using classified identifier types in the system of FIG. 1 according to various embodiments of the disclosure.

FIG. 3 is a flowchart illustrating a first method for hierarchical attribution matching using universal pixel data according to various embodiments of the present disclosure.

FIG. 4 is a flowchart illustrating a second method for universal pixel tracking and attribution according to various embodiments of the present disclosure.

FIG. 5 is a block diagram of a computer system implemented within the system of FIG. 1 according to various embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Digital attribution systems face technical challenges in matching website conversion events to prior targeted data delivery exposures when identifier availability varies across heterogeneous computing environments. Website conversion events may refer to user interactions with a website that represent valuable outcomes for advertisers, including product purchases, account registrations, form submissions, content downloads, subscription sign-ups, appointment bookings, or other actions that advertisers seek to attribute to specific targeted data delivery exposures. Attribution matching systems may rely on device-level identifiers such as third-party cookies to link conversion events to impressions served to the same device. Impressions may refer to instances where targeted data delivery content is displayed or rendered on a user device. Contemporary computing environments limit identifier availability through, for example, browser privacy settings that block third-party cookie storage, mobile operating system restrictions that prevent cross-application tracking, user-initiated opt-out mechanisms, and/or regulatory privacy frameworks. When attribution systems encounter pixel fire events lacking device-level identifiers, single-approach attribution matching systems fail to establish attribution linkages. Pixel fire events may refer to instances when a universal pixel executes on a website and transmits collected data to a data processing system. This results in data processing resource waste as exposure data remains unutilized in data stores despite potential matching opportunities using alternative identifier types. Attribution matching systems must maintain large historical databases of exposure records spanning days or weeks, consuming substantial storage resources. When attribution logic cannot effectively match conversion events against these historical exposure records due to identifier limitations, these storage resources are wasted.

Different identifier types provide varying levels of matching reliability. Durable identifiers such as first-party cookies and mobile data delivery identifiers (also sometimes referred to as advertising identifiers) persist across multiple user sessions and maintain consistent device associations over extended time periods. This enables reliable attribution matching with longer attribution windows. Household identifiers derived from residential Internet Protocol (IP) address mappings enable cross-device attribution within household contexts but provide lower device-level precision. Ephemeral identifiers such as IP addresses have limited temporal persistence due to dynamic reassignment by internet service providers or network address translation. These identifiers may require constrained attribution windows to maintain matching accuracy. Systems that fail to calibrate attribution approaches based on identifier type characteristics produce attribution results with inconsistent reliability. Systems that perform matching exclusively at the device level fail to capture cross-device conversion paths where users view targeted data delivery content on mobile devices and complete conversion actions on computers connected to the same household network.

The present disclosure addresses the aforementioned technical problems in the technical field of distributed data processing systems for digital attribution and cross-device tracking by implementing a hierarchical identifier-based attribution matching system that applies different attribution approaches based on identifier type availability. Durable device-level identifiers may trigger direct matching with extended attribution windows. Residential IP addresses may trigger household-level cross-device attribution through smart household system integration. Ephemeral identifiers may trigger temporal proximity matching with constrained attribution windows. While the durable device-level identifiers, residential identifiers, and/or ephemeral identifiers are used herein as examples of varying types of identifiers with different attribution characteristics, it should be appreciated that the identifier types contemplated herein encompass any other type of device identifier.

The system architecture includes a data processing system that receives pixel data from universal pixels embedded in publisher websites and exposure data from publisher systems. The universal pixel executes when users visit web pages and collects available identifier data. The identifier data may include, for example, cookies, mobile data delivery identifiers, third-party identifier framework values such as Unified ID 2.0 or ID5 identifiers, IP addresses, and/or user interaction event data. Exposure data may refer to records describing targeted data delivery events served to user devices. These records capture when and to whom targeted data delivery content was presented. The data processing system enriches the exposure data by joining or combining raw exposure records with program metadata retrieved from a data store. Program metadata may refer to contextual information describing the characteristics and objectives of targeted data delivery programs. The program metadata includes, for example, publisher account identifiers, program names, targeting parameters, creative identifiers, and/or program objectives. The hierarchical approach disclosed herein may substantially reduce computational resource waste by applying the appropriate matching algorithm based on identifier availability rather than executing multiple matching attempts sequentially.

The temporal architecture of the universal pixel tracking system reflects the distributed timing of targeted data delivery exposure events and subsequent conversion events. During an initial time period spanning days or weeks, the publisher system executes targeted data delivery programs that serve digital data content to user devices. As exposure events occur, the publisher system transmits exposure data to the data processing system on an ongoing basis. The universal pixel application receives this exposure data, enriches the data with program metadata, indexes the data by available identifier types, and stores the data in a data store for a retention period such as thirty days. Subsequently, when a user converts on the website, the universal pixel fires and transmits pixel data to the data processing system. The universal pixel application then performs hierarchical attribution matching by querying the pre-existing enriched exposure data to identify which prior exposure events should be attributed to the current conversion event.

The hierarchical attribution matching system disclosed herein classifies identifier types into different categories based on persistence characteristics and matching reliability. In the example disclosed herein, three categories are presented: durable identifiers, household identifiers, and/or ephemeral identifiers (although it should be appreciated that other identifier types may also be categorized in this manner using the embodiments disclosed herein). Durable identifiers persist across multiple user sessions and maintain consistent device associations over extended time periods. These include, for example, first-party cookies with extended expiration dates, mobile data delivery identifiers such as Apple's IDFA (Apple’s Identifier for Advertisers) or Google's Android Advertising ID, Unified ID 2.0 identifiers, and/or ID5 identifiers. Durable identifiers provide the highest attribution matching reliability because these identifiers maintain stable device associations over extended periods. Household identifiers may be derived from residential IP address mappings maintained by a smart household system. The smart household system analyzes device location patterns to identify IP addresses for residential (e.g., WiFi) networks and assigns household identifiers to groups of devices that consistently connect through the same residential IP address. This enables cross-device attribution by linking conversion events on one device to targeted data delivery exposures served to different devices within the same household. On the other hand, ephemeral identifiers have limited temporal persistence. These include IP addresses subject to dynamic reassignment or network address translation.

When the universal pixel application receives pixel data from a universal pixel fire event, the application classifies the identifier types and selects an appropriate attribution tier based on identifier availability according to policies stored in the data store. An attribution tier may refer to a classification level within the hierarchical matching system that determines which matching approach and attribution window will be applied based on the types of identifiers present in the pixel data. When durable identifiers are detected, first attribution tier logic may be executed, in which the universal pixel application matches the engagement data against enriched exposure data using the durable identifiers within a first attribution window (e.g., up to 30 days). The matching process may compare the durable identifiers extracted from the pixel data against corresponding identifier values stored in the enriched exposure data. When multiple durable identifier types are present, the universal pixel application applies deduplication logic defined in the policies to prevent multiple attribution assignments to the same conversion event. This first attribution tier produces the most accurate attribution because durable identifiers maintain stable device associations over extended time periods. This enables the system to confidently attribute the conversion event to the specific device that both received the targeted data delivery exposure and generated the conversion action.

When durable identifiers are not available but an IP address is present, second attribution tier logic may be executed, in which the universal pixel application determines whether the IP address corresponds to a residential network by querying the smart household system with the IP address. When the smart household system returns a household identifier, the universal pixel application performs household-level attribution by matching the engagement data against enriched exposure data using the household identifier. This matching process may involve, for example, querying the enriched exposure data to retrieve all exposure records where the household identifier field matches the household identifier returned by the smart household system and where the exposure timestamp falls within the attribution window relative to the conversion event timestamp to determine whether any device within the household received a targeted data delivery exposure that can be attributed to the current conversion event. This enables cross-device attribution scenarios where a user views a targeted data delivery exposure on a mobile device and later completes a conversion action on a laptop computer at home. The household-level matching identifies exposure records where any device associated with the household identifier received a targeted data delivery exposure within the attribution window. The system may minimize network communication overhead by selectively querying the smart household system only when residential IP addresses are detected.

When neither durable identifiers nor residential IP address matches are available, third attribution tier logic may be executed, in which the universal pixel application applies temporal proximity matching using IP addresses and timestamps within a different attribution window. Temporal proximity matching may refer to a probabilistic attribution approach that identifies potential attribution linkages by finding temporal correlation between conversion events and exposure events that share the same IP address within a constrained time period. This approach assumes that if the same IP address appears in both an exposure record and a conversion event within a short time window, the exposure and conversion likely originated from the same device or user. This attribution window includes a substantially shorter time period such as up to one hour. This reflects the reduced reliability of IP address matching due to address reuse in mobile carrier networks and network address translation environments. When IP address matches are found within the constrained time period, the universal pixel application generates an attribution report based on these probabilistic attribution linkages. The attribution report includes attribution source indicators and confidence scores that reflect the reduced reliability of this matching approach.

This technical solution directly addresses the aforementioned technical problems by reducing attribution matching failures when durable identifiers are unavailable through hierarchical fallback to household-level and temporal proximity matching approaches. The solution reduces computational resource waste by selecting appropriate matching algorithms based on identifier availability rather than executing multiple matching attempts redundantly. The solution minimizes data storage inefficiencies by enabling utilization of targeted data delivery exposure data across heterogeneous identifier environments through multi-tiered matching logic. The solution optimizes network communication overhead by selectively querying external household graph databases only when residential IP addresses are detected. The solution improves attribution accuracy through tier-specific attribution window calibration that accounts for the persistence characteristics and reliability profiles of different identifier types.

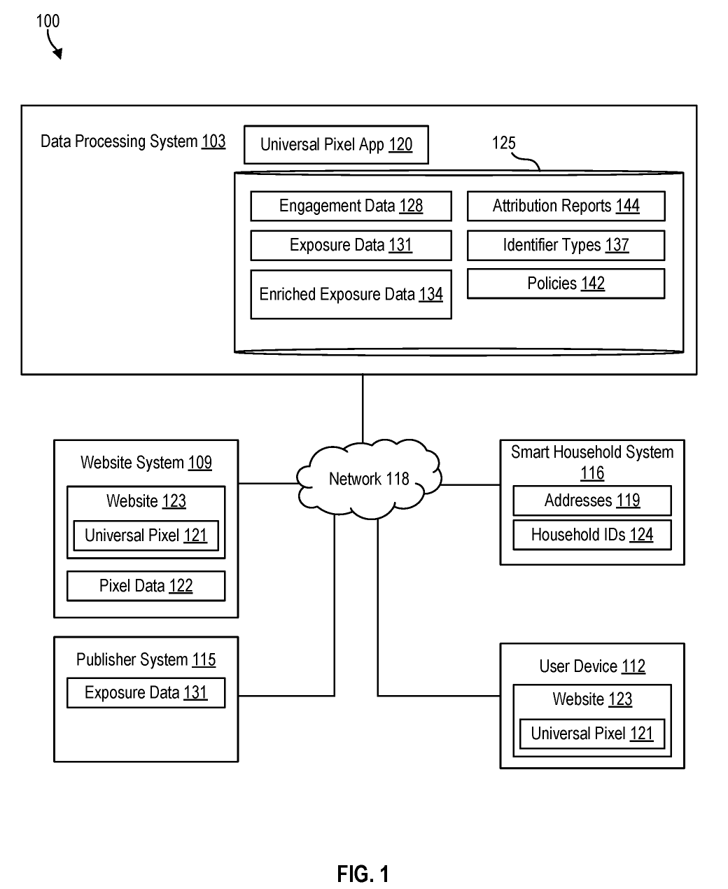

Turning now to FIG. 1, shown is a diagram illustrating a universal pixel tracking system 100 for website engagement attribution using hierarchical identifier-based matching in digital delivery environments according to various embodiments of the disclosure. As shown in FIG. 1, the universal pixel tracking system 100 includes a data processing system 103, a website system 109, a user device 112, a publisher system 115, a smart household system 116, and a network 118. While FIG. 1 illustrates the website system 109, the smart household system 116, and the publisher system 115 as being separate from the data processing system 103, in some embodiments, it should be appreciated that one or more of these systems may be integrated within the data processing system 103 or may be operated by the same entity.

The data processing system 103 may refer to backend server infrastructure configured to receive engagement data from universal pixel fires, receive digital exposure data from publisher systems, perform attribution matching using hierarchical identifier-based logic, and/or generate attribution reports linking website conversion events to digital data exposures. Attribution may refer to the process of linking a website conversion event to the specific digital data exposure that caused the conversion event. The data processing system 103 may be implemented using distributed computing infrastructure including cloud-based server clusters and distributed data processing frameworks. As shown in FIG. 1, the data processing system 103 includes a universal pixel application 120 and a data store 125. As shown in FIG. 1, the data store 125 may store engagement data 128, exposure data 131, enriched exposure data 134, identifier types 137, policies 142, and attribution reports 144.

The universal pixel application 120 may refer to software executing on the data processing system 103 that performs core functions of engagement data collection, data enrichment, attribution matching, and reporting generation. For example, the universal pixel application 120 may be configured to implement policies 142 according to a three-tier hierarchical attribution model, in which Tier 1 attribution logic applies a first attribution window of up to thirty days when durable identifiers such as cookies or mobile digital data identifiers are available, Tier 2 attribution logic performs household-level attribution by querying the smart household system 116 when residential Internet Protocol (IP) addresses can be mapped to household IDs 124, and/or Tier 3 attribution logic performs probabilistic matching within a second attribution window of up to one hour using IP addresses and timestamps. The universal pixel application 120 may be configured to apply policies 142 during attribution matching and generate attribution reports 144 for transmission to publisher system 115.

The engagement data 128 may refer to data collected by the universal pixel 121 when the pixel fires upon user interactions with website 123, transmitted as pixel data 122 to the data processing system 103. For example, the engagement data 128 may comprise multiple types of identifier data including cookies, mobile digital data identifiers, IP addresses, Unified ID 2.0 identifiers, ID5 identifiers, user interaction events such as page views and purchase conversion events, timestamp information, referrer URLs, and/or custom parameters defined by publishers.

The exposure data 131 may refer to records describing targeted data delivery engagement events served to or interacted with by user devices 112. The exposure data 131 may be received continuously by the data processing system 103 as targeted data delivery programs execute, creating a historical database of engagement events that occurred over an extended time period prior to any conversion event. The exposure data 131 may include multiple engagement event types, including bid requests indicating opportunities to serve targeted data delivery content, impression events indicating when targeted data delivery content was displayed on user devices 112, click events indicating when users interacted with targeted data delivery content, video completion events indicating when video-based targeted data delivery content was viewed to completion, and other engagement signals captured during targeted data delivery program execution. The exposure data 131 may also include program identifiers, device identifiers including cookies and mobile digital data identifiers, IP addresses, timestamps, creative identifiers, and/or contextual information about placement locations. The exposure data 131 may be received and stored in data store 125 on an ongoing basis, with individual exposure records potentially existing for days or weeks before a related conversion event occurs that triggers attribution matching against the historical exposure data 131.

In an embodiment, the exposure data 131 received from the publisher system 115 may be assembled from multiple data sources within an ensemble architecture. When targeted data delivery content is served to and displayed on a user device 112, browser-based code or mobile application code executing on the user device 112 may transmit exposure signals back to the data processing system 103. For example, these exposure signals may include win notification identifiers indicating which bid opportunity was successfully won and rendered, impression confirmation messages indicating that targeted data delivery content was displayed to a user, click event notifications indicating user interaction with the displayed content, and/or video completion signals for video-based targeted data delivery.

The enriched exposure data 134 may refer to exposure data 131 that has been processed by the universal pixel application 120 to join raw exposure information with program metadata, creating comprehensive records suitable for attribution matching. The enriched exposure data 134 may include all elements from exposure data 131 plus additional metadata (e.g., publisher account identifiers, program names and identifiers, targeting parameters, and/or campaign objectives). The enriched exposure data 134 may be maintained for a retention period such as, for example, thirty days to enable attribution matching against subsequent conversion events captured in engagement data 128.

The identifier types 137 may refer to a classification system that categorizes available identifiers extracted from pixel data 122 and enriched exposure data 134 (e.g., to determine which tier of the hierarchical attribution model to apply). The identifier types 137 may classify identifiers into categories, such as, for example, durable identifiers with cookies and mobile digital data identifiers that persist across sessions, household identifiers derived from residential IP address mappings, and/or ephemeral identifiers with temporary IP addresses. The universal pixel application 120 may be configured to evaluate identifier types 137 present in each pixel fire event to select the appropriate attribution logic, prioritizing higher-confidence identifier types that enable longer attribution windows.

The policies 142 may refer to configurable rules that govern attribution behavior including deduplication logic, attribution model selection, attribution window durations, identifier precedence hierarchies, and/or privacy filtering criteria. For example, the policies 142 may specify that Tier 1 matches are preferred over Tier 2 matches which are preferred over Tier 3 matches when multiple attribution paths exist. The policies 142 may define multiple attribution models including last-touch attribution crediting the most recent digital data exposure, first-touch attribution crediting the initial digital data exposure, and/or multi-touch attribution distributing credit across multiple exposures. The policies 142 may be configured by publishers through management interfaces to customize attribution behavior for specific campaigns or use cases.

The attribution reports 144 may refer to data outputs generated by the universal pixel application 120 that aggregate attribution results to provide publishers with insights into program performance. The attribution reports 144 may include, for example, conversion counts aggregated by campaign, time period, geographic region, and/or audience segment, along with calculated metrics such as conversion rates, cost per conversion, and/or return on data delivery/advertising spend. The attribution reports 144 may include attribution source indicators identifying which tier of the hierarchical attribution model generated each attribution. For example, the attribution reports 144 may be transmitted to publisher system 115 through application programming interfaces or presented through web-based dashboards.

The website system 109 may refer to web server infrastructure operated by a publisher or content provider (advertiser or brand) that serves website content to user devices and embeds tracking code for engagement measurement. As shown in FIG. 1, the website system 109 includes a website 123 and a universal pixel 121 embedded within website markup.

The universal pixel 121 may refer to a code snippet, such as JavaScript code, embedded in website 123 pages that executes client-side when a user visits the website to collect engagement data and transmit pixel data 122 to the data processing system 103. The universal pixel 121 may be configured to collect multiple types of identifier data (e.g., cookies, mobile digital data identifiers, IP addresses, Unified ID 2.0 identifiers, ID5 identifiers, and/or user interaction events). When the universal pixel 121 fires upon specified trigger events, the collected engagement data is transmitted as pixel data 122 (e.g., in HTTP requests) to the data processing system 103.

The pixel data 122 may refer to the data payload transmitted from the universal pixel 121 to the data processing system 103 when the pixel fires, containing engagement data 128 collected during user interactions with website 123. The pixel data 122 may include, for example, all available identifiers, timestamp information, event type indicators, custom conversion values, and/or contextual metadata about the user session.

The user device 112 may refer to computing devices operated by end users that access websites and are exposed to digital data content. The user device 112 may be, for example, smartphones, tablet computers, laptop computers, desktop computers, connected television devices, or other internet-enabled computing devices. The user device 112 may execute web browser applications or mobile applications that render website content from the website system 109 and execute the universal pixel 121 code. The user device 112 may be associated with various device identifiers including device-specific cookies, mobile digital data identifiers, and/or network identifiers such as IP addresses. In some embodiments, the user device 112 may have privacy settings enabled that block or limit cookie storage or may have user-initiated opt-out settings that restrict identifier availability. The user device 112 may display the website 123 with the universal pixel 121.

The publisher system 115 may refer to targeted data delivery technology infrastructure that facilitates the serving of targeted data delivery content to user devices 112 and the collection of exposure data 131 describing those delivery events. The publisher system 115 may refer an ensemble of data sources and systems including publisher-operated platforms that manage digital data delivery programs and campaigns, intermediary systems that process bid requests and impression opportunities, browser-based or application-based code executing on user devices 112 that transmits exposure signals when targeted data delivery content is displayed, and/or internal data stores 125 maintained by the data processing system 103 that contain bid request logs and campaign configuration metadata. The publisher system 115 may include, for example, demand-side platforms, supply-side platforms, content servers, advertisement/data servers, creative management systems, and/or campaign/program management interfaces. In an embodiment, exposure data 131 attributed to the publisher system 115 may originate from multiple sources within this ensemble architecture. For example, when targeted data delivery content is displayed on a user device 112, browser-based tracking code may transmit an exposure signal to the data processing system 103 indicating which bid opportunity was won and rendered. The data processing system 103 may then retrieve associated metadata from internal bid logs and campaign configuration data stored in data store 125 to create a complete exposure record. This ensemble approach enables comprehensive exposure data collection without requiring all data elements to originate from a single external publisher entity. The publisher system 115 may be configured to transmit exposure data 131 to the data processing system 103 including, for example, bid request data, impression event data, and/or click event data. The publisher system 115 may be configured to receive attribution reports 144 from the data processing system 103 indicating which targeted data delivery exposures led to website conversion events, enabling campaign optimization decisions.

The smart household system 116 may refer to a database system that maintains mappings between residential network IP addresses 119 and household identifiers 124, enabling household-level attribution and cross-device tracking without relying on personal identifiers. As shown in FIG. 1, the smart household system 116 includes addresses 119 and household identifiers (IDs) 124. The smart household system 116 may be configured to identify residential IP addresses 119 by analyzing location patterns, assign household IDs 124 to groups of devices that consistently connect through the same residential IP address 119, and/or respond to queries from the universal pixel application 120 by receiving IP addresses extracted from pixel data 122 and returning household IDs 124 when the IP addresses correspond to known residential WiFi networks in the addresses 119. The addresses 119 may refer to a database of IP addresses that have been classified as residential WiFi network addresses based on device location patterns and network characteristics. The addresses 119 may be queried by the universal pixel application 120 (e.g., during Tier 2 attribution processing to determine whether an IP address extracted from pixel data 122 corresponds to a known residential network). The household IDs 124 may refer to unique identifiers assigned to households served by residential WiFi networks, enabling cross-device attribution within household contexts without tracking individual users. The household IDs 124 enable the universal pixel application 120 to attribute conversion events occurring on one device to data exposures served to different devices within the same household.

The network 118 may refer to communication networks enabling data transmission between the components of the universal pixel tracking system 100. The network 118 may comprise internet protocol networks including the public internet, cellular data networks including 4G LTE and 5G networks, WiFi networks including residential WiFi and public WiFi hotspots, and/or local area networks.

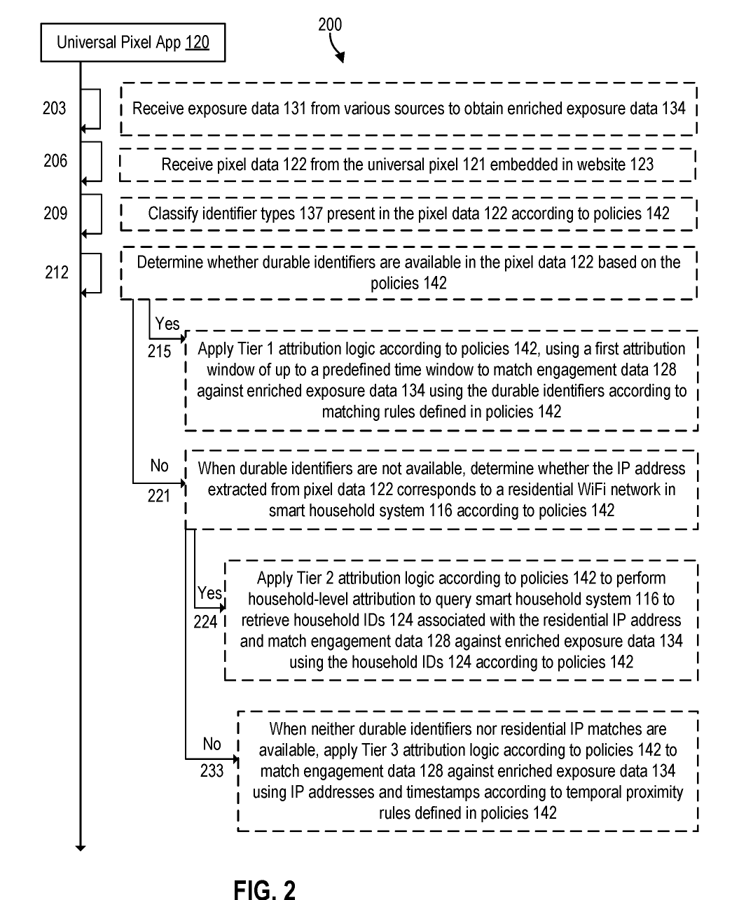

Turning now to FIG. 2, shown is a diagram illustrating method 200 for hierarchical attribution matching using universal pixel data according to various embodiments of the disclosure. In particular, method 200 may be performed by the universal pixel application 120 executing at the data processing system 103. Method 200 may implement the policies 142 to select attribution approaches based on identifier types 137 available in pixel data 122.

Method 200 may begin with operation 203. At operation 203, the universal pixel application 120 may receive exposure data 131 from publisher system 115, which may comprise an ensemble of data sources as described above. For example, the exposure data 131 may describe digital data (e.g., advertisement) exposures served to user devices 112, including bid requests, impression events indicating when digital data were displayed, click events indicating when users interacted with digital data, video completion events indicating when video content was viewed to completion, and/or other engagement events captured during targeted data delivery program execution. The exposure data 131 may be received continuously as targeted data delivery programs execute, creating an ongoing stream of exposure records that are processed and stored before any related conversion events occur. The universal pixel application 120 may enrich the exposure data 131 with program metadata to generate enriched exposure data 134 at the time the exposure data 131 is received, rather than waiting for subsequent conversion events. The enrichment process transforms raw exposure records into comprehensive attribution-ready records by joining each exposure event with associated program metadata retrieved from data store 125 based on program identifiers present in the exposure data 131. The enriched exposure data 134 is indexed by available identifier types 137 including cookies, mobile digital data identifiers, household identifiers derived through smart household system 116 queries, and IP addresses, enabling efficient attribution matching when pixel fire events subsequently occur. The universal pixel application 120 maintains the enriched exposure data 134 in data store 125 for a retention period such as thirty days, creating a historical database of attribution-ready exposure records spanning weeks of targeted data delivery activity that occurred prior to any conversion events.

At operation 206, the universal pixel application 120 may receive pixel data 122 from the universal pixel 121 embedded in website 123. The pixel data 122 may be transmitted when the universal pixel 121 fires upon user interactions with website 123, such as page views, form submissions, or purchase conversion events.

At operation 209, the universal pixel application 120 may classify identifier types 137 present in the pixel data 122 according to policies 142. For example, classification may categorize identifiers into durable identifiers such as cookies and mobile digital data identifiers that persist across sessions, household identifiers that can be derived from residential IP address mappings, ephemeral identifiers such as temporary IP addresses 119, etc. The identifier types 137 classification may determine which tier of the hierarchical attribution model to apply based on the policies 142.

At decision 212, the universal pixel application 120 may determine whether durable identifiers are available in the pixel data 122 based on the policies 142. The policies 142 may define which identifier types qualify as durable identifiers. When durable identifiers are detected according to the policies 142, method 200 may proceed to operation 215 to apply Tier 1 attribution logic. When durable identifiers are not available due to privacy settings, cookie blocking, or device limitations, method 200 may proceed to decision 221.

At operation 215, the universal pixel application 120 may apply Tier 1 attribution logic according to policies 142. The Tier 1 attribution logic may refer to an attribution matching approach that uses durable identifiers to match conversion events against data delivery exposures within a first attribution window. The matching process may compare cookies, mobile digital data identifiers, ID5 identifiers, or Unified ID 2.0 identifiers extracted from pixel data 122 against corresponding identifiers in enriched exposure data 134 to identify digital data exposures that preceded the conversion event. The policies 142 may specify the duration of the first attribution window, for example, a predefined time window of up to thirty days, and/or may define deduplication rules for handling multiple durable identifier types. The universal pixel application 120 may implement deduplication logic according to policies 142 to prevent multiple attribution assignments when multiple identifier types are present. Upon successful Tier 1 matching, method 200 may proceed to generate an attribution report.

At decision 221, when durable identifiers are not available, the universal pixel application 120 may determine whether the IP address extracted from pixel data 122 corresponds to a residential WiFi network in smart household system 116 according to policies 142. The policies 142 may specify the criteria for residential IP address matching and may define confidence thresholds for household-level attribution. The universal pixel application 120 may query addresses 119 in smart household system 116 to determine whether the IP address has been classified as a residential network address. When a residential IP address 119 match is found meeting the criteria in policies 142, method 200 may proceed to operation 224. When no residential IP address 119 match is found, method 200 may proceed to operation 233.

At operation 224, the universal pixel application 120 may apply Tier 2 attribution logic according to policies 142 to perform household-level attribution. The Tier 2 attribution logic may refer to an attribution matching approach that uses residential IP addresses mapped to household identifiers to match conversion events against digital data exposures served to any device within the same household. The universal pixel application 120 may query smart household system 116 with the residential IP address to retrieve household IDs 124 that identify groups of devices consistently connecting through the same residential WiFi network. The matching process may identify data delivery exposures served to any device associated with the household IDs 124 within the attribution window, enabling cross-device attribution scenarios where a user views a targeted data delivery exposure on a mobile device and later completes a conversion action on a laptop computer at home. The policies 142 may define attribution window durations for Tier 2 matching, for example, up to thirty days, and/or may specify cross-device attribution rules. Upon successful Tier 2 matching, method 200 may proceed to generate an attribution report.

At operation 233, when neither durable identifiers nor residential IP address 119 matches are available, the universal pixel application 120 may apply Tier 3 attribution logic as a fallback according to policies 142. The Tier 3 attribution logic may refer to an attribution matching approach that uses probabilistic matching based on IP address and timestamp proximity to match conversion events against recent digital data exposures. The matching process may compare the IP address and timestamp of the pixel fire event against IP addresses and timestamps of recent digital data exposure events within a second attribution window, applying temporal proximity logic to create speculative attribution linkages. The policies 142 may specify the second attribution window duration, for example, up to one hour, reflecting reduced reliability due to IP address 119 reuse and network address translation in mobile carrier networks. The policies 142 may also define confidence scoring for Tier 3 matches. Upon Tier 3 matching, method 200 may proceed to generate an attribution report.

Upon successful matching through any of the three attribution tiers, the universal pixel application 120 may generate an attribution report with an attribution source indicator identifying which tier of the hierarchical attribution model generated the attribution. The attribution report may include conversion event details, the matched digital data exposure, campaign identifiers, time delta between exposure and conversion, and/or confidence indicators based on the attribution tier used and the policies 142 applied. The attribution report may aggregate attribution results to provide publishers with insights into campaign performance, including conversion counts aggregated by campaign, time period, geographic region, and/or audience segment, along with calculated metrics such as conversion rates, cost per conversion, and/or return on advertising spend.

The universal pixel application 120 may transmit the attribution report to publisher system 115 through application programming interfaces or web-based dashboards, enabling advertisers to assess campaign performance and make optimization decisions based on attribution results. The attribution report may enable advertisers to adjust budget allocation, refine targeting parameters, modify creative strategies, and/or optimize campaign configurations based on which digital data exposures generated conversions.

The enrichment process performed at operation 203 may transform raw exposure data 131 into enriched exposure data 134 by joining targeted data delivery exposure events with descriptive program information immediately upon receipt of the exposure data 131, rather than deferring enrichment until attribution matching is required. This upstream enrichment approach reduces computational overhead during time-sensitive attribution matching operations by ensuring enriched exposure data 134 is pre-computed and indexed before pixel fire events occur. Program metadata may refer to descriptive information about data delivery programs that provides context for attribution matching, including publisher account identifiers that specify which publisher is running the program, program identifiers that uniquely identify each data delivery program, program names that provide human-readable labels, creative identifiers that specify which content variations or designs were displayed, targeting parameters that define audience criteria such as geographic regions, demographic attributes, or behavioral characteristics, budget information that specifies spending limits or pacing rules, and/or program objectives that indicate desired outcomes such as conversions, awareness, or engagement. The program metadata may be stored in data store 125 and associated with program identifiers, enabling the universal pixel application 120 to join exposure data 131 with the corresponding program metadata based on matching program identifiers present in both data sets.

The universal pixel application 120 may perform the enrichment process by receiving exposure data 131 from publisher system 115, extracting program identifiers from the exposure data 131, querying data store 125 to retrieve program metadata associated with the extracted program identifiers, and/or joining the program metadata with the exposure data 131 to create enriched exposure data 134. For example, when the publisher system 115 transmits exposure data 131 indicating that an impression event occurred for program identifier "PROG\_12345" on a device with a specific mobile digital data identifier at a specific timestamp, the universal pixel application 120 may query data store 125 to retrieve program metadata for "PROG\_12345" including the publisher account identifier, program name, targeting parameters, and/or creative identifier, and/or may combine this program metadata with the impression event details to create an enriched exposure data record stored as enriched exposure data 134. The enrichment process occurs immediately as exposure data 131 is received, potentially days or weeks before any related conversion event occurs, ensuring that when a pixel fire event subsequently triggers attribution matching, the universal pixel application 120 can efficiently query pre-enriched, pre-indexed exposure records rather than performing enrichment operations during time-sensitive attribution processing. The enrichment process may enable more precise attribution matching by providing additional context about which programs, creatives, and/or targeting strategies were associated with each targeted data delivery exposure.

The enriched exposure data 134 created through the enrichment process may be indexed by identifier types 137 and stored in data store 125 for a retention period defined by policies 142, such as thirty days, enabling subsequent attribution matching operations to efficiently query enriched exposure data 134 based on identifiers extracted from pixel data 122 when pixel fire events occur days or weeks after the original exposure events. For example, the enriched exposure data 134 may be indexed by cookies, mobile digital data identifiers, the identifiers obtained through queries to smart household system 116, and/or IP addresses, allowing the universal pixel application 120 to rapidly retrieve relevant targeted data delivery exposure events when performing Tier 1, Tier 2, or Tier 3 attribution matching according to the hierarchical attribution model described in FIG. 2. The temporal separation between exposure data receipt and enrichment at operation 203 and subsequent pixel data receipt at operation 206 reflects the practical reality that users may view targeted data delivery content days or weeks before converting, requiring the data processing system 103 to maintain a rolling historical database of enriched exposure records ready for attribution matching against future conversion events.

In an embodiment, the engagement data 128 and enriched exposure data 134 may be used by a dynamic audience targeting (DAT) system to optimize audience selection and targeting rules for bid requests. The DAT system may refer to an automated system that analyzes historical engagement patterns and conversion data to generate targeting rules that identify high-value audience segments for future targeted data delivery programs. The DAT system may communicate with the data processing system 103 to access engagement data 128 and enriched exposure data 134 stored in data store 125, enabling the DAT system to evaluate which audience characteristics, device types, geographic regions, or behavioral patterns correlate with conversion events captured by the universal pixel 121. Additional details on the DAT system is described in U.S. Pat. App. No. 19/220,007, entitled “METHODS AND SYSTEMS FOR DYNAMIC AUDIENCE TARGETING,” by Aaron McKee et. al., which is hereby incorporated by reference in its entirety.

The DAT system may be configured to determine an audience for a bid request based on the engagement data 128 from the universal pixel 121. For example, when the publisher system 115 evaluates a bid request for a data delivery opportunity, the DAT system may query the data processing system 103 to retrieve engagement data 128 indicating which identifier types 137, household IDs 124, or user characteristics have historically generated conversion events for similar program types. The DAT system may apply machine learning algorithms or statistical analysis to the engagement data 128 to calculate propensity scores indicating the likelihood that a particular user or household will convert, enabling the publisher system 115 to make more informed bidding decisions based on predicted conversion probability.

The DAT system may be configured to determine targeting rules for bid requests based on the engagement data 128 and attribution reports generated through the hierarchical attribution model. The targeting rules may specify audience criteria such as geographic regions, time windows, device types, or behavioral attributes that should be prioritized or excluded when evaluating bid opportunities. For example, if attribution reports indicate that Tier 2 household-level attributions generated through smart household system 116 produce higher conversion rates for a particular program type, the DAT system may generate targeting rules that prioritize bid requests associated with residential IP addresses in the addresses 119 database. The DAT system may continuously update targeting rules based on ongoing attribution results, creating a feedback loop that improves audience targeting precision over time as additional engagement data 128 is collected through the universal pixel 121.

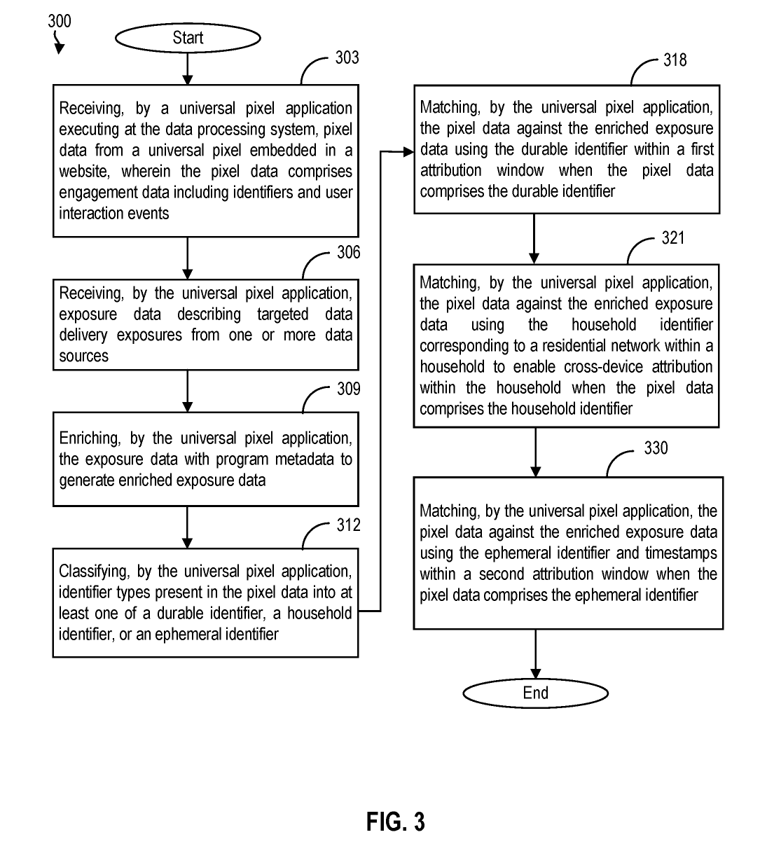

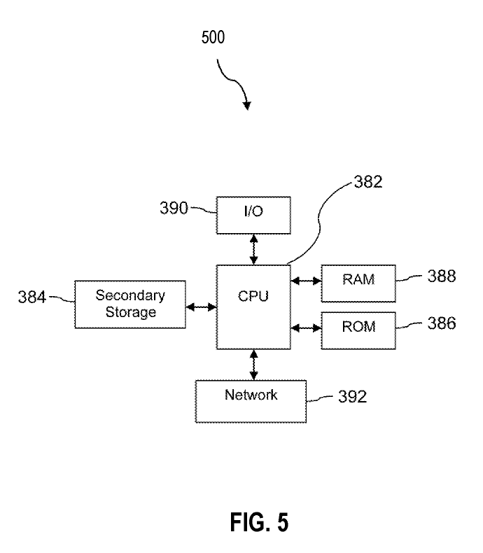

Turning now to FIG. 3, shown is a method 300 for hierarchical attribution matching using universal pixel data according to an embodiment of the present disclosure. Method 300 may be performed by the universal pixel application 120 executing at the data processing system 103. In the embodiments, the method 300 may be implemented using a computer system with components as shown in FIG. 5. As illustrated, method 300 of FIG. 3 includes a number of enumerated operations, but embodiments of the operations in FIG. 3 may include additional operations before, after, and in between the enumerated operations. In some embodiments, one or more of the enumerated operations may be omitted or performed in a different order.

At step 303, method 300 comprises receiving, by the universal pixel application 120, pixel data 122 from a universal pixel 121 embedded in a website 123. In an embodiment, the pixel data 122 comprises engagement data 128 including at least one of cookies, mobile digital data identifiers, IP addresses, Unified ID 2.0 identifiers, ID5 identifiers, user interaction events, timestamps, or referrer information. The pixel data 122 may be transmitted via HTTP or HTTPS requests when the universal pixel 121 fires upon user interactions with the website 123.

At step 306, method 300 comprises receiving, by the universal pixel application 120, exposure data 131 from a describing targeted data delivery exposures served to user devices 112 from one or more data sources (e.g., a publisher system 115, other platforms, user devices 112, etc.). The exposure data 131 may include bid requests, impression events, click events, and/or associated metadata such as program identifiers, device identifiers, timestamps, and/or creative identifiers.

At step 309, method 300 comprises enriching, by the universal pixel application 120, the exposure data 131 with program metadata to generate enriched exposure data 134. The enrichment process may involve extracting program identifiers from the exposure data 131, querying data store 125 to retrieve program metadata associated with the program identifiers, and joining the program metadata with the exposure data 131 to create comprehensive records suitable for attribution matching.

At step 312, method 300 comprises classifying, by the universal pixel application 120, identifier types 137 present in the pixel data 122 into categories comprising durable identifiers, household identifiers, and/or ephemeral identifiers. This classification determines which attribution approach will be applied based on the policies 142 stored in data store 125.

At step 318, method 300 comprises matching, by the universal pixel application 120, the pixel data 122 against the enriched exposure data 134 using the durable identifier within a first attribution window when the pixel data 122 comprises a durable identifier. The first attribution window may comprise a predefined number of days, such as up to thirty days. This enables the universal pixel application 120 to identify targeted data delivery exposures that occurred prior to the conversion event. The durable identifier provides persistent identification across user sessions and enables deterministic attribution matching.

At step 321, method 300 comprises matching, by the universal pixel application 120, the pixel data 122 against the enriched exposure data 134 using the household identifier corresponding to a residential network within a household when the pixel data 122 comprises the household identifier. The universal pixel application 120 may query the smart household system 116 to obtain the household identifier associated with a residential IP address extracted from the pixel data 122. The smart household system 116 may return household identifiers 124 that identify groups of devices consistently connecting through the same residential network. This enables cross-device attribution by linking conversion events occurring on one device to targeted data delivery exposures served to different devices within the same household.

At step 330, method 300 comprises matching, by the universal pixel application 120, the pixel data 122 against the enriched exposure data 134 using the ephemeral identifier and timestamps within a second attribution window when the pixel data 122 comprises the ephemeral identifier. The ephemeral identifier may comprise an IP address and timestamp without corresponding durable identifiers or household identifiers. The second attribution window may comprise a shorter time period, such as up to one hour. This applies temporal proximity matching to create probabilistic attribution linkages based on IP address and timing correlation.

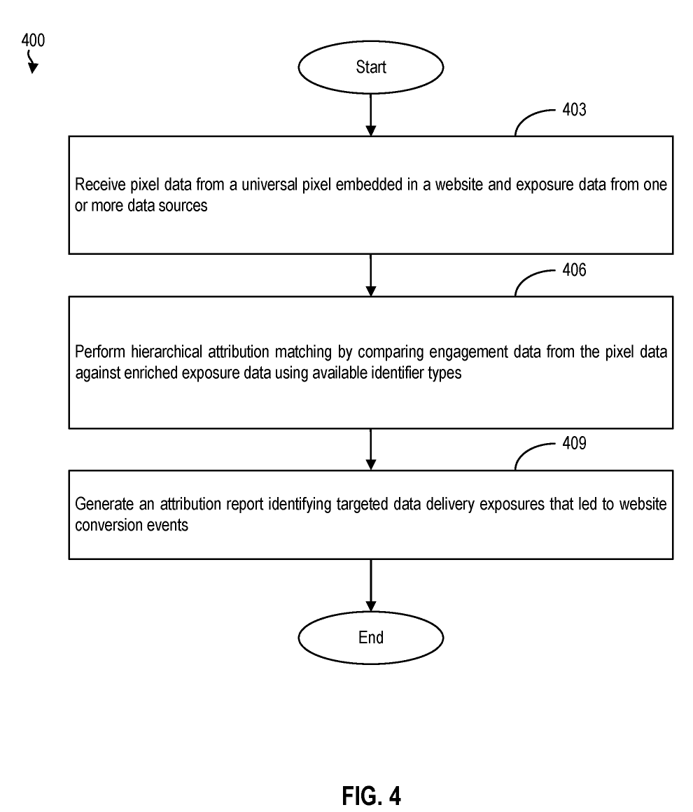

Turning now to FIG. 4, shown is a method 400 for universal pixel tracking and attribution according to an embodiment of the present disclosure. Method 400 may be performed by the universal pixel application 120 executing at the data processing system 103. In embodiments, the method 400 may be implemented using a computer system with components as shown in FIG. 5. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 comprises receiving, by the universal pixel application 120, pixel data 122 from a universal pixel 121 embedded in a website 123 and exposure data 131 from one or more data sources (e.g., a publisher system 115, other platforms, user devices 112, etc.). The pixel data 122 may contain engagement data 128 collected when users interact with the website 123, and the exposure data 131 may describe targeted data delivery exposures served to user devices 112 through the publisher system 115.

At step 406, method 400 comprises performing, by the universal pixel application 120, hierarchical attribution matching by comparing the engagement data 128 from the pixel data 122 against enriched exposure data 134 using available identifier types 137. Hierarchical attribution matching may refer to a multi-tiered attribution process that selects different matching approaches based on the types of identifiers available in the pixel data 122. In an embodiment, higher-confidence identifier types are prioritized over lower-confidence identifier types to maximize attribution accuracy while maintaining coverage. The hierarchical attribution matching performed at step 406 may comprise the operations described in FIG. 2, including classifying identifier types 137 at operation 209, determining whether durable identifiers are available at decision 212, matching using durable identifiers at operation 215 when available, determining whether residential IP addresses can be mapped to household identifiers at decision 221, querying the smart household system 116 and matching using household IDs 124 at operation 224 when residential IP address 119 matches are found, and matching using IP addresses and timestamps at operation 233 as a fallback when neither durable identifiers nor residential IP address 119 matches are available. The hierarchical nature of the matching process ensures that the universal pixel application 120 applies the most reliable attribution approach available for each conversion event based on the identifier types 137 present in the pixel data 122 and the policies 142 governing attribution behavior.

At step 409, method 400 comprises generating, by the universal pixel application 120, an attribution report identifying targeted data delivery exposures that led to website conversion events. Website conversion events may refer to user interactions with website 123 that represent valuable outcomes for publishers, including product purchases, account registrations, form submissions, content downloads, subscription sign-ups, appointment bookings, video completions, or other actions that publishers seek to attribute to specific targeted data delivery exposures. The attribution report generated at step 409 may aggregate conversion events by program, time period, geographic region, and/or audience segment, and may include calculated metrics such as conversion rates, cost per conversion, and/or return on advertising spend.

FIG. 5 illustrates a computer system 500 suitable for implementing one or more embodiments disclosed herein. In an embodiment, the data processing system 103, website system 109, user device 112, publisher system 115, and/or smart household system 116, may each be implemented as the computer system 500. The computer system 500 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 500, at least one of the CPU 382, the RAM 388, and the ROM 386 are changed, transforming the computer system 500 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 500 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 500 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 500 to provide the functionality of a number of servers that is not directly bound to the number of computers in the computer system 500. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 500, at least portions of the contents of the computer program product to the secondary storage 384, to the ROM 386, to the RAM 388, and/or to other non-volatile memory and volatile memory of the computer system 500. The processor 382 may process the executable instructions and/or data structures in part by directly accessing the computer program product, for example by reading from a CD-ROM disk inserted into a disk drive peripheral of the computer system 500. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 500.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 500 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A universal pixel tracking system for website engagement attribution using hierarchical identifier-based matching, wherein the system comprises:
a data processing system configured to:
receive pixel data from a universal pixel embedded in a website;
receive exposure data from a publisher system describing targeted data delivery exposures served to user devices;
enrich the exposure data with program metadata to generate enriched exposure data, wherein the program metadata comprises at least one of publisher account identifiers, program names, targeting parameters, or program objectives;
classify identifier types present in the pixel data into categories comprising at least one of a durable identifier, a household identifier, or an ephemeral identifier;
when the pixel data comprises a durable identifier, match the pixel data against the enriched exposure data using the durable identifier within a first attribution window;
when the pixel data comprises the household identifier corresponding to a residential network within a household, match the pixel data against the enriched exposure data using the household identifier to enable cross-device attribution within the household;
when the pixel data comprises the ephemeral identifier, match the pixel data against the enriched exposure data using the ephemeral identifier and timestamps within a second attribution window; and
generate an attribution report identifying which targeted data delivery exposure led to a website conversion event; and
transmit the attribution report to the publisher system; and
a smart household system communicatively coupled to the data processing system and configured to maintain mappings between residential addresses and household identifiers, wherein the smart household system receives addresses extracted from the pixel data and returns household identifiers when the addresses correspond to residential networks.

2. The universal pixel tracking system of claim 1, wherein the durable identifier comprises at least one of cookies stored in browser local storage, mobile digital data identifiers assigned by device operating systems, ID5 identifiers, or Unified ID 2.0 identifiers.

3. The universal pixel tracking system of claim 1, wherein the first attribution window comprises a predefined number of days, and wherein the second attribution window comprises up to one hour.

4. The universal pixel tracking system of claim 1, wherein the pixel data comprises engagement data including at least one of cookies, mobile digital data identifiers, Internet Protocol (IP) addresses, Unified ID 2.0 identifiers, ID5 identifiers, user interaction events, timestamps, or referrer information, wherein the enriched exposure data is indexed by identifier types comprising one or more of cookies, mobile digital data identifiers, the household identifiers, and IP addresses, and wherein the enriched exposure data is maintained in a data store for a retention period.

5. The universal pixel tracking system of claim 1, wherein the exposure data comprises at least one of program identifiers, device identifiers, Internet Protocol (IP) addresses, timestamps, and creative identifiers.

6. The universal pixel tracking system of claim 1, wherein the data processing system is configured to apply policies during attribution matching, wherein the policies govern deduplication logic, attribution model selection, attribution window durations, identifier precedence hierarchies, and privacy filtering criteria.

7. The universal pixel tracking system of claim 5, wherein the policies define multiple attribution models comprising at least one of last-touch attribution crediting a most recent targeted data delivery exposure, first-touch attribution crediting an initial targeted data delivery exposure, or multi-touch attribution distributing credit across multiple exposures.

8. A method for hierarchical attribution matching using universal pixel data in a data processing system, wherein the method comprises:
receiving, by a universal pixel application executing at the data processing system, pixel data from a universal pixel embedded in a website, wherein the pixel data comprises engagement data including identifiers and user interaction events;
receiving, by the universal pixel application, exposure data from a publisher system describing targeted data delivery exposures;
enriching, by the universal pixel application, the exposure data with program metadata to generate enriched exposure data;
classifying, by the universal pixel application, identifier types present in the pixel data into at least one of a durable identifier, a household identifier, or an ephemeral identifier;
matching, by the universal pixel application, the pixel data against the enriched exposure data using the durable identifier within a first attribution window when the pixel data comprises the durable identifier;
matching, by the universal pixel application, the pixel data against the enriched exposure data using the household identifier corresponding to a residential network within a household to enable cross-device attribution within the household when the pixel data comprises the household identifier; and
matching, by the universal pixel application, the pixel data against the enriched exposure data using the ephemeral identifier and timestamps within a second attribution window when the pixel data comprises the ephemeral identifier.

9. The method of claim 8, further comprising generating, by the universal pixel application, an attribution report with an attribution source indicator identifying which matching approach generated the attribution.

10. The method of claim 8, wherein enriching the exposure data comprises:
extracting, by the universal pixel application, program identifiers from the exposure data;
querying, by the universal pixel application, a data store to retrieve program metadata associated with the program identifiers; and
joining, by the universal pixel application, the program metadata with the exposure data.

11. The method of claim 8, wherein enriching the exposure data comprises enriching the exposure data immediately upon receipt from the publisher system before any conversion event occurs, and wherein the enriched exposure data is indexed by identifier types and maintained in a data store for a retention period to enable subsequent attribution matching.

12. The method of claim 8, further comprising applying, by the universal pixel application, policies during attribution matching, wherein the policies comprise deduplication logic to prevent multiple attribution assignments when multiple identifier types are present.

13. The method of claim 8, further comprising communicating, by the universal pixel application, with a dynamic audience targeting system to provide the engagement data for determining targeting rules for bid requests.

14. A non-transitory computer-readable medium storing instructions that, when executed by one or more processors of a data processing system, cause the data processing system to:
receive pixel data from a universal pixel embedded in a website and exposure data from a publisher system;
perform hierarchical attribution matching by comparing engagement data from the pixel data against enriched exposure data using available identifier types; and
generate an attribution report identifying targeted data delivery exposures that led to website conversion events.

15. The non-transitory computer-readable medium of claim 14, wherein performing hierarchical attribution matching comprises matching using durable identifiers when available, matching using household identifiers when residential IP addresses are detected, and matching using IP addresses and timestamps when neither durable identifiers nor residential IP address matches are available.

16. The non-transitory computer-readable medium of claim 14, wherein the instructions further cause the data processing system to apply policies during attribution matching, wherein the policies govern at least one of deduplication logic, attribution window durations, or identifier precedence hierarchies.

17. The non-transitory computer-readable medium of claim 14, wherein the durable identifiers comprise at least one of cookies, mobile digital data identifiers, ID5 identifiers, or Unified ID 2.0 identifiers.

18. The non-transitory computer-readable medium of claim 14, wherein the enriched exposure data comprises program metadata including at least one of publisher account identifiers, program names, targeting parameters, or program objectives.

19. The non-transitory computer-readable medium of claim 14, wherein the instructions further cause the data processing system to communicate with a dynamic audience targeting system that determines targeting rules for bid requests based on the engagement data.

20. The non-transitory computer-readable medium of claim 14, wherein the instructions further cause the data processing system to enrich the exposure data by joining exposure events with program metadata based on program identifiers.
